(19) United States
(12) Patent Application Publication
(10) Pub. No.: US 2011/0010279 A1
(43) Pub. Date: Jan. 13, 2011

(54) Laundry payment and monitoring system

(75) Inventor: Robert J. Tuttle, Littleton, MA (US)

Correspondence Address: LINDA SERAFINI, VP & GENERAL COUNSEL;MAC-GRAY CORPORATION, 404 WYMAN STREET, WALTHAM, MA, 02451, US

(73) Assignee: MAC-GRAY CORPORATION

(21) Appl. No.: 12/803,682

(22) Filed: Jul. 2, 2010

Related U.S. Application Data
(60) Provisional application No. 61/270,383, filed on Jul. 8, 2009.

(51) Int. Cl. G06Q 10/00; G06Q 30/00; G06K 7/00; G06F 15/16

(52) U.S. Cl. 705/30; 705/1.1; 235/380; 709/250; 709/219; 709/217

(57) ABSTRACT

A laundry center for monitoring operational and payment data for laundry machines in a laundry facility in which the data is collected and transmitted over a powerline communication link using the wire distribution lines from which the machines receive power.

### RELATED APPLICATIONS

This application is utility application conversion of provisional application for U.S. patent Ser. No. 61/270,383, filed Jul. 8, 2009 and claims priority thereof.

### FIELD OF THE INVENTION

The disclosed embodiments generally relate to the networking of a group of laundry appliances within a laundry facility to facilitate the operation, use, and maintenance of the appliances for the convenience of customers and operators of the facility. In particular monitoring of machine performance and payment for laundry services is facilitated by adapting controls to permit the use of payment media supported by remote account services and for monitoring system payments, collections, and performance using a powerline network.

### BACKGROUND OF THE INVENTION

A system of laundry appliances that are networked for consolidated control is described in U.S. Pat. No. 7,469,288. In the system of this application, the operation of an individual appliance is monitored using a gang controller, connected to each of the appliances, to collect data related to the status and operation of an appliance and transmit the data to a centralized controller over a local area network. Systems of this type are hard wired to allow signals from an appliance to be received by a common controller and sent on to a server within the local area network, the server permits the transmission of data to remote location over an Internet connection. In U.S. Pat. No. 6,167,387, there is described a cashcard system for purchasing laundry services. In this system each machine in a facility is equipped with a card reader and each facility has a terminal that communicates with the card readers and a remote control center by means of a mobile communications network. The above systems represent examples of prior art systems used in laundry facilities and each uses expensive communication systems to interconnect the components of the system.

The problem to which this application is directed is to construct a system by which individual appliances in a laundry facility can be interconnected for local and remote monitoring as well as remote payment accounting, without the need for constructing or installing expensive wired or wireless communication systems.

### BRIEF DESCRIPTION OF THE INVENTION

One aspect of the embodiments of the invention described in this application is to provide a device or system for use in laundry machine installations that will provide cost effective and convenient performance and payment monitoring of laundry machine usage in a laundry facility.

Another aspect of the embodiments described is to provide a convenient network in the form of a powerline interface through which the laundry machines of a laundry facility may be interconnected for communication with a laundry center to monitor payment and performance of individual machines within a facility.

Another aspect of the invention is to provide a laundry center monitoring module constructed to collect diagnostic, payment, and collection data for individual machines in the facility.

An embodiment of the payment and performance monitoring system of this application is deployed in a laundry facility having, multiple laundry machines, such as washers and dryers. In this embodiment, each machine is provided with a meter that functions to collect diagnostic data available from an internal machine controller. Each of the diagnostic data collection meters is connected through a powerline network to a central processor that forms a part of a central laundry facilities management center serving the facility. The laundry center contains a microprocessor that executes software to provide monitoring of the status and performance of individual machines and processing of payments. The diagnostic collection meters interface with machine controllers to extract machine diagnostic data. The diagnostic data is transmitted over a facilities network to and from the laundry center.

In a preferred embodiment of this application, a local area network is established within the laundry facility based on a low bandwidth, power line interface within the laundry facility using existing wire infrastructure. The power line interface provides communication between the data collection meter and the laundry center.

In another aspect of the invention, laundry service purchase transactions may be based on a locally issued payment card that is established through a credit card backed accounting system provided by a remote credit service. The system could also be adapted to accept credit card or debit card transactions. A card reader is connected within the central facilities management module to collect data from the payment card and provide payment for laundry services. In the most basic configuration, a coin transaction module may be connected to accept coins in payment for laundry services. The diagnostic data may be accessed by a remote laundry operations server also connected by means of an internet gateway or other communications link. Diagnostic data as well as payment data may be accessed on site by using portable memory devices such as thumb drives and the like.

### BRIEF DESCRIPTION OF THE DRAWINGS

The features of the subject matter of this application are explained in the following description, with reference to the accompanying drawings, in which:

FIG. 1 is a block diagram of an embodiment of the basic system of this application in which a number of laundry machines are connected to a facilities manager center by means of a powerline communications link;

FIG. 2 is a block diagram of an alternate embodiment of the system of FIG. 1, showing additional detail;

FIG. 3 is a block diagram of an alternate embodiment of the system of FIG. 1, showing alternate transaction components; and

FIG. 4 is a schematic block diagram of an embodiment of a power line communication device as used in the embodiment of FIG. 1.

### DETAILED DESCRIPTION OF THE EMBODIMENTS

Although the present invention will be described with reference to the embodiments shown in the drawings, it should be understood that the present invention may have alternate forms. In addition, any suitable size, shape or type of elements or materials could be used. The computer operated devices described in this application may be constructed having one or several processors and one or several program product modules stored in one or several memory elements. For illustration, computer components may be described as individual units by function. It should be understood, that in some instances, these functional components may be combined. A laundry machine installation of the general type in which the system of this application may be used is discussed in U.S. Pat. No. 7,469,288, that issued to an inventor common to the subject application. The disclosure of the '288 patent is incorporated herein by reference.

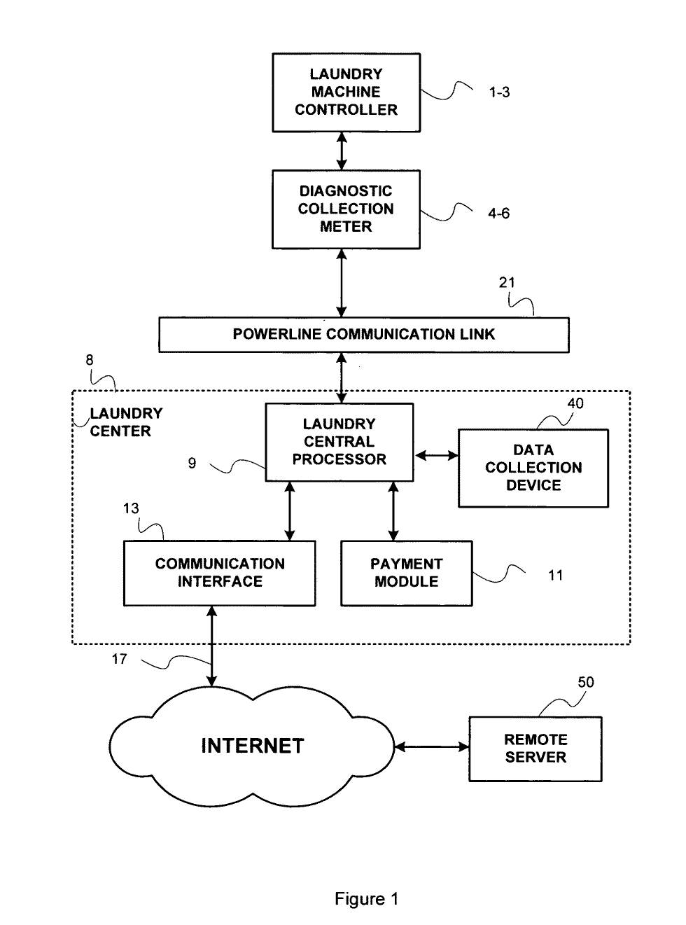

A laundry machine management system is illustrated in FIG. 1 and consists of multiple laundry machines 1-3, each of the machines is coupled to a diagnostic data collection meter 4-6. The laundry facility generally includes washers and dryers arranged for convenient operation in a structure such as an apartment building, dormitory or the like and are generally available to residents. Facilities of this type could also be installed in Laundromat style enterprises that are available to the general public. The number and assortment of machines are generally based on the customer base and can vary widely. For convenience three machines are illustrated, but it should be understood that many machines can be incorporated into the embodiments of this application.

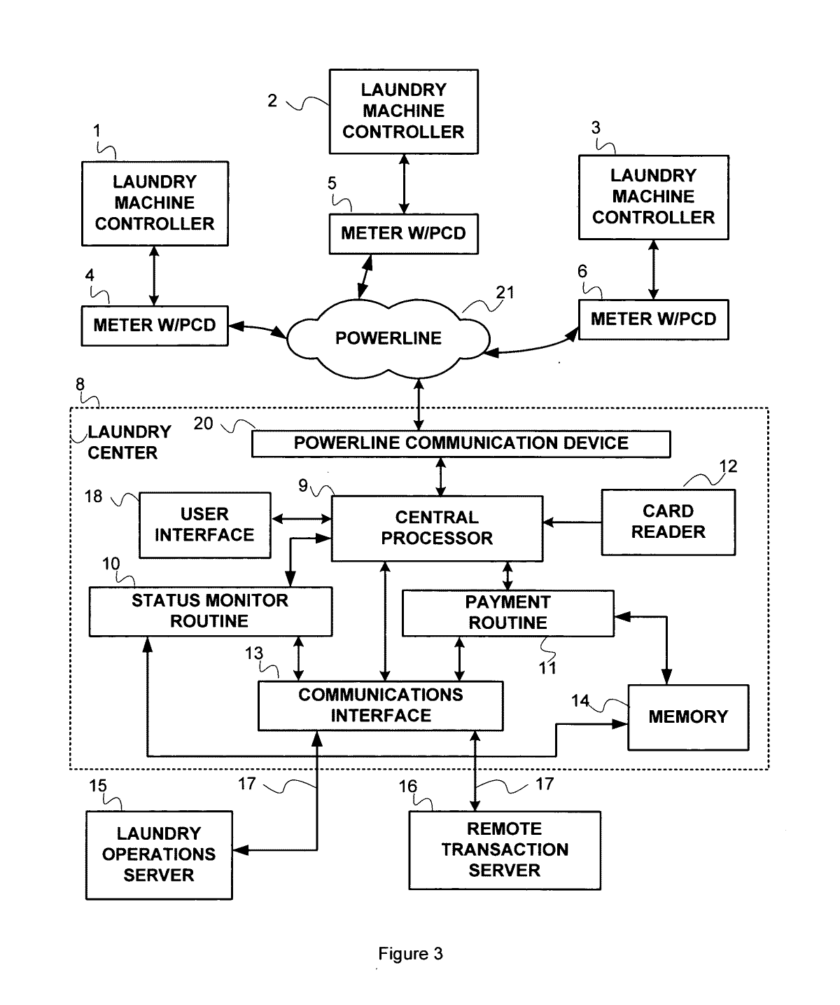

The diagnostic collection meters 4-6 interface with the controllers of each of the machines 1-3 to extract data relating to machine operation. Diagnostic data collection meters 4-6 may also be adapted to issue commands to the machines, such as start, stop, and others. Each of the diagnostic data collection meters interfaces with the laundry center 8 to send the status signals and receive control commands to and from the laundry center 8. Each of the diagnostic data collection meters 4-6 is connected to a central processor 9 that forms a part of the laundry center 8, as illustrated in FIG. 1. In general it is intended that one laundry center 8 serves a facility or at least a significant number of machines. The laundry center 8 may be constructed in the form of a wall mounted console or other convenient installation depending on the features provided. For example, in its most basic form the laundry center provides only a data management function and as such only needs to be accessible to facilities management personnel. However, in the more complex form, as illustrated in FIG. 3, the user interface 18 and card reader 12 may require access by customers of the facility, therefore the location of the laundry center 8 needs to provide convenient access.

Laundry center 8 as illustrated in FIG. 1 contains central microprocessor 9 in which a convenient data collection port is provided, for example, in its most simple form, a connection such as a USB port may be provided. This will allow for connection to a portable memory device that is used to off load performance and diagnostic data and perform the function of data collection device 40. This function may be performed by facilities management technicians for accounting and performance checking at a remote facility. As shown in FIG. 1, performance and payment data may also be transmitted directly to a remote server 50 through a communications interface 13 via the internet.

The portable memory device may take many different forms such as those know as “thumb drives”, “memory sticks” and other similar devices that provide an identifiable memory module. Such collector devices would contain identifying files in memory for security. The USB interface may be used to support a different medium for transporting data. For instance a Bluetooth connection to a cell phone. A portable communications device, such as a cell phone or small computer with a communication capability might also provide this function.

It may be advantageous in some facilities to provide a payment module 11 as part of the laundry center 8 for accepting payments in return for laundry machine operation at a central location in the facility. The most basic configuration would provide a device for accepting coins as payment for machine operation. A coin acceptance device may be incorporated as part of the laundry center 8.

In some applications, it may be more advantageous to have coin acceptance a function that is distributed to each individual laundry machine. A coin acceptance device would be placed in each machine and this function would be monitored by the diagnostic collection meters at each machine. In the latter configuration, the operational data collected would include payment data that could be analyzed to permit reconciliation of machine operation against funds collected. This would provide security against theft that is a continuous problem in coin operated laundry facilities, thereby making coin operation a more practical alternative.

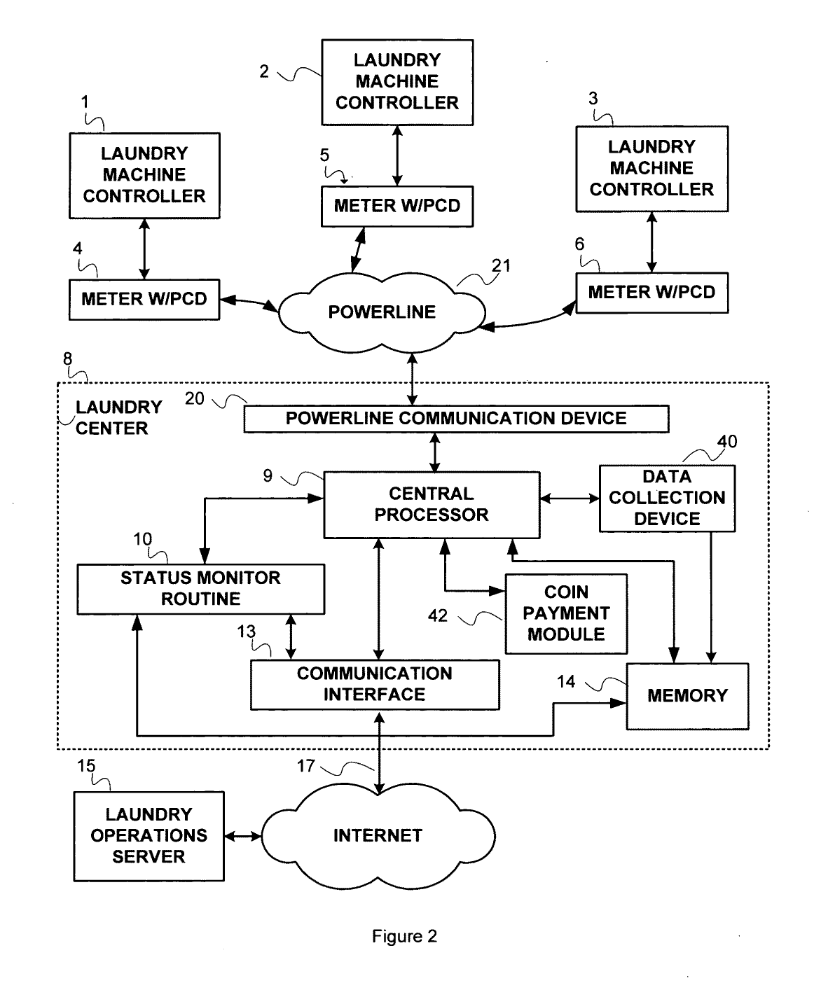

As shown in FIG. 2 laundry center 8 may be configured to execute software routine 10 that is to designed analyze collected data and store performance histories in memory 14. Such analysis could provide real time monitoring of the status of the machines 1-3 and transmit maintenance alarms and other advisories to prompt service calls to the facility. In the embodiment shown in FIG. 3, a card reader 12 is incorporated into laundry center module 8 and is adapted to collect transaction information from a payment card (not shown) used in payment for the laundry services and machine start up. Operational/status/performance data and in this case transaction information may be stored in memory 14. Transaction information may only be stored to the extent permitted by payment industry regulations. Memory 14 may be configured to provide access to identifiable portable memory devices 40 as described above.

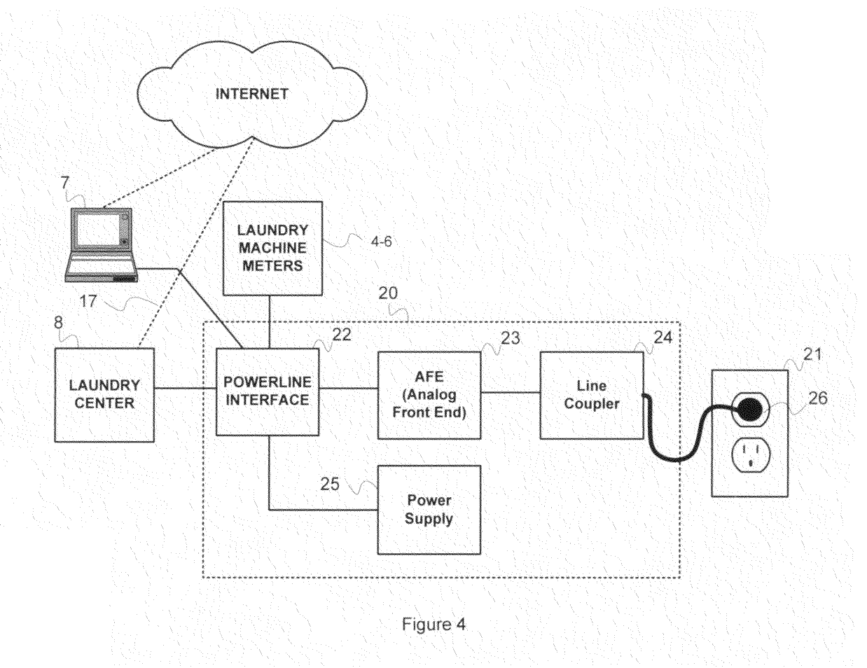

As further illustrated in the embodiment of FIG. 3, communications interface 13 within laundry center module 8, is connected to provide a communication link 17 to remote server 50, as shown in FIG. 1, or remote servers 15 and 16, as shown in FIG. 3, by which the operational data and transaction information respectively may be transmitted for processing. In particular, with respect to transactional data, appropriate security methods would be used to prevent access to the transactional data from a remote site. Access to memory 14 of the laundry center module 8 by transaction server 16 would be limited. Communication link 17 may comprise any of the available means, such as a wireless modem for transmission over a wireless network. In an alternate embodiment, see FIGS. 2 and 4, an internet protocol gateway could also be incorporated into communication interface 13 of laundry center module 8 for accessing the Internet over an Ethernet coupled modem, or wireless telephone connection. In another embodiment, communication link 17 may be established by a plain old telephone service (POTS). In this instance a telephone modem interface would be added to the communication interface 13 of laundry center module 8 for communication directly with the remote servers 15 and 16.

A remote laundry operations server 15 is adapted to receive operational data and to monitor performance of the laundry system. Remote transaction server 16, serves as an accounting clearing house for accounts set up to purchase laundry services at a particular facility or to process credit or debit card payments.

As illustrated in FIG. 4, communications within the facility is provided by a powerline communication device (PCD) 20 of the type developed by Yitran Communications Ltd., having an office in San Jose, Calif. This device uses the existing wire infrastructure 21 of the facility to interconnect the components of the system for data communication through receptacle 26. This is particularly advantageous in this application, as each of the laundry machines 1-3 and related accessories are connected to common power supply wiring. The power line device 20 connects to powerline communication link 21 between each of the diagnostic data collection meters 4-6 and the laundry center 8. Each meter 4-6 would also be constructed with a PCD to couple each machine to the powerline communication link 21. In another embodiment this communication link may provide data communication with an internet gateway, such as may be provided by a personal computer 7, or directly from laundry center 8, as shown in FIG. 4.

A powerline communication device 20 adapted for the functions indicated above is shown in FIG. 4 and is constructed according to the specifications promulgated by the Homeplug Powerline Alliance, Inc. of San Ramon Calif. The powerline communications device 20 may be integrated into laundry center module 8, as shown in the figures, and generally comprises an interface 22 to provide compatible links to the components within the linked system. Analog Front End (AFE) 23 and Line Coupler 24 connect the powerline communication device to the physical network medium, namely, wire powerline 21. AFE 23 includes reception and transmission paths, with the required filtering and amplification. The line coupler 24 couples the data to the powerline link 21. Powerline communication device 20 may be provided power by power supply 25 which may be part of laundry center module 8 or a separate block.

In this manner a communication link 21 is provided, within the laundry room facility using existing wired infrastructure. This avoids the need for expensive installation of network cabling or wireless systems to provide communications both internally and to internet gateways.

Laundry service purchase transactions may be based on a locally issued payment card that is be established through a credit card backed accounting system provide by a remote credit service. This may be particularly advantageous when the laundry facility is for use of a limited population such as a college dormitory or apartment complex. In some instances it may be convenient or otherwise advantageous to adapt the payment routine 11 to accept common credit or debit card transactions. As shown in FIGS. 2 and 3, a card reader 12 is connected within the laundry center to collect data from the payment card for transmittal via a wide area network, telephone link, wireless communication network or other means to a credit card or other type of transaction server. The transaction data can also be transmitted by an appropriate telephone link as indicated above.

The system of this application is therefore, designed to take advantage of the extensive diagnostic data now available at the laundry machine controller. This data has become more sophisticated with the increased use of processor based controllers in current machine designs. For example, access to a washing machine controller may provide data relating to: door lock sensor failure, motor speed, temperature, or current error detection, timer sensor fault, water level sensor failure, slow fill or drain rate warnings, and others. A dryer may provide data relating to: motor sensor failure, door sensor failure, temperature sensor failure, over temperature alarm, motor control circuit failure, and others. Examples of other data available includes: blocked coin drop control circuit failure, card reader not communicating, and others. The data available will vary from manufacturer to manufacturer. The system of this application makes this data conveniently available at a central location to both on site and remote maintenance personnel. This allows for prompt attention to current or potential problems with a resulting reduction in machine downtime.

It should be understood that the above description is only illustrative of the invention. Various alternatives and modifications can be devised by those skilled in the art with out departing from the invention.

What is claimed is:

1. A system comprising:
a plurality of laundry machines, installed in a facility for providing laundry services, each of the laundry machines having integrated controllers configured to compile operational data for an individual machine;
a diagnostic collection meter mounted on each of the laundry machines in communication with the integrated controller of an individual machine to collect operational data therefrom;
a laundry center module having a central processor in communication with each of the diagnostic collection meters to receive operational data over a network connected to each of the diagnostic collection meters, the central processor configured to collect the operational data for transmittal to a remote destination; and
wherein the network interconnecting the diagnostic collection meters comprises a low bandwidth, powerline communication link within the laundry facility, using a wire infrastructure that provides power to the laundry machines.

2. The system of claim 1 wherein the diagnostic collection meter further comprises a powerline interface device for connection to the powerline communication link.

3. The system of claim 1 wherein the laundry center further comprises a powerline interface device for connection to the powerline communication link.

4. The system of claim 1 wherein the laundry center further comprises a payment module for processing payments for operating the laundry machines.

5. The system of claim 4 wherein the payment module comprises a coin acceptance device and further wherein the operational data collected includes payment data suitable for reconciling payments received with coin collection records.

6. The system of claim 4 wherein the payment module comprises a card reader for reading card data and transmitting such data to the central processor and wherein the central processor is configured to process received card data using a remote transaction server.

7. The system of claim 1 wherein the laundry center further comprises a memory for storing collected operational data and wherein said memory is accessible by means of a portable data collection device.

8. The system of claim 1 wherein the laundry center further comprises a communication interface connected to the central processor and wherein the central processor is configured to send operational data to a remote server over the Internet using the communication interface.

9. The system of claim 8 wherein the payment module comprises a card reader for reading card data and transmitting such data to the central processor wherein the central processor is further configured to send card data over the Internet using the communication interface to a remote transaction server for processing the payment for machine operation using the card data.

10. The system of claim 9 wherein the card comprises a credit or debit card.

11. The system of claim 9 wherein the card comprises a laundry facility issued payment card.

12. The system of claim 9 wherein the card comprises a cash card.

13. The system of claim 1 wherein the remote destination comprises a portable memory device.

14. The system of claim 1 wherein the remote destination comprises a remote server accessible over the Internet.

15. The system of claim 1 wherein each of the laundry machines are constructed with a coin acceptance device and wherein the coin acceptance device is monitored by the diagnostic collection meters and the operational data collected includes payment data suitable for reconciling payments received with coin collection records for each of the laundry machines.
